(19) United States
(12) Patent Application Publication
(10) Pub. No.: US 2025/0246814 A1
(43) Pub. Date: Jul. 31, 2025

(54) FEED NETWORK, PHASE SHIFTER, AND ANTENNA APPARATUS

(71) Applicant: HUAWEI TECHNOLOGIES CO., LTD., Shenzhen (CN)

(72) Inventors: Chaochao LI, Xi’an (CN); Qiqiang GAO, Dongguan (CN); Rui GUAN, Xi’an (CN); Weimin LI, Xi’an (CN); Yongzhan CHEN, Dongguan (CN)

(73) Assignee: HUAWEI TECHNOLOGIES CO., LTD., Shenzhen, GD (CN)

(21) Appl. No.: 19/185,572

(22) Filed: Apr. 22, 2025

Related U.S. Application Data
(63) Continuation of application No. PCT/CN2023/118924, filed on Sep. 14, 2023.

(30) Foreign Application Priority Data
Oct. 28, 2022 (CN) 202211337821.5

(51) Int. Cl. H01Q 5/50; H01Q 1/24; H01Q 3/36

(52) U.S. Cl. CPC H01Q 5/50; H01Q 3/36; H01Q 1/246

(57) ABSTRACT

Embodiments of this application provide a feed network. The feed network includes a housing, and at least one accommodation cavity is disposed in the housing. A transmission structure, a support, and a phase shift medium are disposed in each accommodation cavity. The support is located in the accommodation cavity, and the support is connected to at least one inner wall of the accommodation cavity. In a first direction, the support includes a bearing surface, an inner wall that is of the accommodation cavity and that is opposite to the bearing surface and the bearing surface are spaced apart, and the transmission structure is disposed on a surface of the bearing surface. In the first direction, the phase shift medium is disposed between the transmission structure and one of inner walls of the accommodation cavity, and the phase shift medium is slidably connected to the support in a second direction.

### CROSS-REFERENCE TO RELATED APPLICATIONS

This application is a continuation of International Application No. PCT/CN2023/118924, filed on Sep. 14, 2023, which claims priority to Chinese Patent Application No. 202211337821.5, filed on Oct. 28, 2022. The disclosures of the aforementioned applications are hereby incorporated by reference in their entireties.

### TECHNICAL FIELD

Embodiments of this application relate to the field of communication technologies, and in particular, to a feed network, a phase shifter, and an antenna apparatus.

### BACKGROUND

With development of communication technologies, users have increasingly high requirements on a transmission speed and transmission bandwidth of a network. To meet requirements of people, communication technologies are also gradually developed from 2G, 3G, and 4G to 5G. As important constituent parts for mobile communication, base station antennas are also evolved with the development of the communication technologies 2G, 3G, 4G, and 5G. The base station antennas are gradually evolved from initial single-frequency and dual-frequency technologies to multi-frequency and massive multiple-input multiple-output (massive MIMO) technologies. As a core component of the base station antenna, a feed network is used to change a phase of a radiating element, to implement downtilt of an antenna beam.

However, a complex structure of a feed network in a related technology causes high costs. The high costs of the feed network as an important constituent part of the base station antenna affects competitiveness of the base station antenna.

### SUMMARY

Embodiments of this application provide a feed network, a phase shifter, and an antenna apparatus. The feed network has a simple structure and low costs.

According to a first aspect, an embodiment of this application provides a feed network, including a housing, where at least one accommodation cavity is disposed in the housing, and a transmission structure, a support, and a phase shift medium are disposed in each accommodation cavity. The support is located in the accommodation cavity, and the support is connected to at least one inner wall of the accommodation cavity. In a first direction, the support includes a bearing surface, an inner wall that is of the accommodation cavity and that is opposite to the bearing surface and the bearing surface are spaced apart, and the transmission structure is disposed on a surface of the bearing surface. In the first direction, the phase shift medium is disposed between the transmission structure and one of inner walls of the accommodation cavity, and the phase shift medium is slidably connected to the support in a second direction. The first direction is a thickness direction of the feed network, the second direction is a sliding direction of the phase shift medium, and the first direction is perpendicular to the second direction.

According to the feed network provided in embodiments of this application, at least one accommodation cavity is disposed, and the transmission structure, the support, and the phase shift medium are disposed in each accommodation cavity, so that different accommodation cavities can be connected to radiating elements that are with different polarizations and that are of an antenna apparatus. The support is disposed to provide positions for disposing the transmission structure and the phase shift medium. The bearing surface is disposed on the support, and the inner wall that is of the accommodation cavity and that is opposite to the bearing surface and the bearing surface are spaced apart, to provide mounting space for the transmission structure, and prevent the transmission structure from being connected to the inner wall of the accommodation cavity. In addition, a distance between the transmission structure and the accommodation cavity may be adjusted by adjusting a position of the bearing surface in the first direction, to improve design flexibility of the feed network. In addition, the support can be disposed to improve consistency of indicators of the feed network, and reduce fluctuation of the indicators. The phase shift medium is disposed between the transmission structure and one of the inner walls of the accommodation cavity, so that in comparison with a technical solution in which phase shift media are disposed on both sides of the transmission structure in a related technology, in the technical solution in embodiments of this application, fewer phase shift media are disposed, thereby simplifying a structure of the feed network and reducing costs. The phase shift medium is slidably connected to the support in the second direction, so that the feed network can adapt to different working requirements, and applicability of the feed network is improved.

In a possible implementation, the housing includes a first side wall and a second side wall. In the first direction, the first side wall and the second side wall are disposed opposite to each other, a first gap exists between one of the first side wall and the second side wall and the transmission structure, and a second gap exists between the other one of the first side wall and the second side wall and the transmission structure. The first gap is larger than or equal to the second gap.

The first gap and the second gap are disposed to provide disposing space for the phase shift medium. The first gap is disposed to be greater than or equal to the second gap, so that the transmission structure may be located at different positions between the first side wall and the second side wall. This improves the design flexibility of the feed network.

In a possible implementation, in the first direction, the first gap is larger than the second gap, and the phase shift medium is located in the second gap.

The first gap is disposed to be greater than the second gap, so that the transmission structure can be closer to one of the inner walls (the first side wall or the second side wall) of the accommodation cavity. In this way, a distance between the transmission structure and the inner wall that is of the accommodation cavity and that is opposite to the transmission structure can be shortened, and phase shift efficiency can be improved. The phase shift medium is disposed in the second gap, that is, the phase shift medium is disposed in a small gap, so that thickness of the phase shift medium in the first direction can be reduced, thereby reducing costs.

In a possible implementation, in the first direction, the first gap is equal to the second gap, and the phase shift medium is located in the first gap or the second gap.

The first gap is disposed to be equal to the second gap, so that the first side wall and the second side wall can be symmetrically disposed relative to the transmission structure in the first direction, that is, distances from the transmission structure to the first side wall and to the second side wall are equal. Therefore, the phase shift medium can be disposed in the first gap or the second gap. This improves the design flexibility of the phase shift medium and improves the applicability of the feed network.

In a possible implementation, the housing is of an integrated structure. The housing further includes a third side wall and a fourth side wall. In a third direction, the third side wall and the fourth side wall are disposed opposite to each other. One end of the third side wall is connected to the first side wall, and the other end is connected to the second side wall. One end of the fourth side wall is connected to the first side wall, and the other end is connected to the second side wall. The third direction is perpendicular to both the first direction and the second direction.

The third side wall and the fourth side wall are disposed, so that the first side wall, the second side wall, the third side wall, and the fourth side wall may be connected to enclose the housing, and the accommodation cavity is formed in the housing. The first side wall, the second side wall, the third side wall, and the fourth side wall may be configured to accommodate the transmission structure, the phase shift medium, and the support, and may be further configured to protect the transmission structure, the phase shift medium, and the support. The housing is disposed as the integrated structure to facilitate production.

In a possible implementation, the housing is of a split structure. Both the first side wall and the second side wall are of “U”-shaped structures. In the first direction, the first side wall includes a first opening, and the second side wall includes a second opening. The first opening and the second opening are disposed opposite to each other, orthographic projections of the first side wall and the second side wall in the first direction at least partially overlap, orthographic projections of the first side wall and the second side wall in a third direction at least partially overlap, and the third direction is perpendicular to both the first direction and the second direction. In the third direction, partial structures that are of the first side wall and the second side wall and that are opposite to each other are coupled to each other.

The housing is disposed as the split structure, the first side wall and the second side wall are disposed as the “U”-shaped structures, the first opening and the second opening are disposed opposite to each other, and in the third direction, the partial structures that are of the first side wall and the second side wall and that are opposite to each other are coupled to each other, so that the accommodation cavity is formed between the first side wall and the second side wall. In addition, the “U”-shaped structure is easy to process, processing costs of the housing can be reduced, and costs of the feed network can be further reduced.

In a possible implementation, at least one convex wall is disposed between the first side wall and the second side wall, the at least one convex wall is spaced apart along the third direction, so that a plurality of accommodation cavities are formed between the first side wall, the second side wall, and the convex wall, and the transmission structure, the support, and the phase shift medium are disposed in each accommodation cavity.

At least one convex wall is disposed between the first side wall and the second side wall, so that a plurality of accommodation cavities can be formed between the first side wall and the second side wall. Because the transmission structure, the support, and the phase shift medium are disposed in each accommodation cavity, different accommodation cavities can be connected to the radiating elements that are with different polarizations and that are of the antenna apparatus. In this way, one feed network can meet requirements of the radiating elements with different polarizations, thereby simplifying the feed network structure and reducing costs.

In a possible implementation, a first end of the convex wall is fastened to one of the first side wall and the second side wall; a second end of the convex wall extends in the first direction to be close to the other one of the first side wall and the second side wall, and the second end of the convex wall is coupled to the other one of the first side wall and the second side wall.

The first end of the convex wall is fastened to one of the first side wall and the second side wall, and the second end of the convex wall is coupled to the other one of the first side wall and the second side wall, so that two accommodation cavities can be formed on two sides of the convex wall in the third direction, and no interference is generated between signals of transmission structures located in the two accommodation cavities.

In a possible implementation, an extension part is disposed at the second end of the convex wall, the extension part extends in the third direction, and the extension part is coupled to the other one of the first side wall and the second side wall.

The extension part is disposed, so that a relative area between the convex wall and the other one of the first side wall and the second side wall can be increased, thereby improving coupling efficiency between the convex wall and the other one of the first side wall and the second side wall.

In a possible implementation, the support includes a slide rail, and the slide rail extends in the second direction. The phase shift medium is slidably disposed in the slide rail. The slide rail is configured to support the phase shift medium and is configured for the phase shift medium to slide in the second direction.

The slide rail is disposed on the support, so that the phase shift medium can slide on the support, and the slide rail can limit travel of the phase shift medium. This ensures working precision of the feed network.

In a possible implementation, the support is of a plate-like structure. The support includes a first surface and a second surface, and the first surface and the second surface are disposed away from each other. The first surface is connected to one of the first side wall and the second side wall, and the second surface is disposed opposite to the other one of the first side wall and the second side wall. The transmission structure is disposed on the second surface, and the second surface is the bearing surface.

The support is disposed as the plate-like structure, so that a structure of the support can be simplified, costs can be reduced, and mounting is convenient.

In a possible implementation, the slide rail is of a groove-shaped structure provided on the support, and the phase shift medium is slidably disposed in the groove-shaped structure. The phase shift medium is nested in the support, and an orthographic projection of the phase shift medium in the second direction is located in an orthographic projection of the support in the second direction.

The slide rail is disposed as the groove-shaped structure provided on the support, so that space occupied by the phase shift medium can be reduced, which is conducive to miniaturization development of the feed network.

In a possible implementation, in the first direction, a distance between the first surface and the second surface is smaller than a distance between the second surface and the other one of the first side wall and the second side wall.

The distance between the first surface and the second surface is disposed to be less than the distance between the second surface and the other one of the first side wall and the second side wall, so that the transmission structure can be close to the first side wall or the second side wall, that is, the transmission structure is biased toward one of the first side wall or the second side wall. In this way, energy on an inner wall close to the transmission structure can be increased, thereby improving phase shift efficiency of the feed network.

In a possible implementation, in the first direction, one end of the support is connected to the first side wall, and the other end of the support is connected to the second side wall.

One end of the support is connected to the first side wall, and the other end of the support is connected to the second side wall, so that stability of the support can be improved.

In a possible implementation, in the third direction, the two ends of the support are respectively connected to the inner walls of the accommodation cavity, and the third direction is perpendicular to both the first direction and the second direction.

The two ends of the support are respectively connected to the inner walls of the accommodation cavity in the third direction, so that stability of the support can be improved, and large disposition space can be provided for the phase shift medium and the transmission structure. In addition, when disposition space required by the phase shift medium and the transmission structure is the same, a size of the accommodation cavity can be reduced. This facilitates miniaturization development of the feed network.

In a possible implementation, the support is a circuit board or a three-dimensional plastic member.

The support is disposed as the circuit board, so that another circuit board does not need to be disposed on the feed network. This simplifies the structure of the feed network and reduces the costs. The support is disposed as the three-dimensional plastic member, the consistency of the indicators of the feed network can be improved, and a structure of the three-dimensional plastic member can be flexibly disposed, thereby improving the design flexibility of the feed network.

In a possible implementation, each housing includes a first cable outlet interface and a second cable outlet interface. A partial structure of the transmission structure is located in the first cable outlet interface, and the first cable outlet interface is configured to connect to a radiating element of an antenna. A partial structure of the transmission structure is located in the second cable outlet interface, and the second cable outlet interface is configured to connect to an antenna connector.

According to a second aspect, an embodiment of this application provides a phase shifter, including the foregoing feed network.

According to the phase shifter provided in this embodiment of this application, the foregoing feed network is disposed, so that a structure can be simplified, and costs can be reduced.

According to a third aspect, an embodiment of this application provides an antenna apparatus, including a radiating element and the foregoing feed network. The radiating element is electrically connected to a transmission structure of the feed network.

According to the antenna apparatus in this embodiment of this application, the feed network in the first aspect is disposed, so that a structure of the antenna apparatus can be simplified, thereby reducing costs of the antenna apparatus.

### BRIEF DESCRIPTION OF DRAWINGS

FIG. 1 is a diagram of a structure of an antenna system according to an embodiment of this application;

FIG. 2 is a diagram of a framework structure of an antenna apparatus according to an embodiment of this application;

FIG. 3 is a diagram of a structure of a feed network according to an embodiment of this application;

FIG. 4 is a schematic exploded view of a structure of a feed network according to an embodiment of this application;

FIG. 5 is a diagram of a cross-sectional structure of a feed network according to an embodiment of this application;

FIG. 6 is a diagram of a partial structure of a support of a feed network according to an embodiment of this application;

FIG. 7 is a diagram of a partial structure of a support and a phase shift medium of a feed network according to an embodiment of this application;

FIG. 8 is a diagram of a cross-sectional structure of a feed network according to an embodiment of this application;

FIG. 9 is a schematic exploded view of a structure in another embodiment of a feed network according to an embodiment of this application;

FIG. 10 is a diagram of a structure of a support and a phase shift medium of a feed network according to an embodiment of this application;

FIG. 11 is a diagram of a cross-sectional structure of a feed network according to an embodiment of this application;

FIG. 12 is a diagram of another cross-sectional structure of a feed network according to an embodiment of this application;

FIG. 13 is a diagram of a cross-sectional structure in another embodiment of a feed network according to an embodiment of this application;

FIG. 14 is a schematic exploded view of a structure in another embodiment of a feed network according to an embodiment of this application;

FIG. 15 is a diagram of structures of a first side wall and a second side wall of a feed network according to an embodiment of this application;

FIG. 16 is a diagram of an exploded structure of a partial structure of a feed network according to an embodiment of this application;

FIG. 17 is a diagram of a cross-sectional structure of a feed network according to an embodiment of this application; and

FIG. 18 is a diagram of another cross-sectional structure of a feed network according to an embodiment of this application.

### REFERENCE NUMERALS

1: antenna system; 10: antenna apparatus; 20: fastening bracket; 30: pole; 40: grounding apparatus;
11: radiating element; 12: phase shifter; 13: calibration network; 14: filter; 15: combiner;
16: antenna connector; 17: reflection plate;
100: feed network; 110: housing; 111: accommodation cavity; 112: first cable outlet interface; 113: second cable outlet interface;
114: first side wall; 1141: first opening; 115: second side wall; 1151: second opening; 1152: convex wall; 1153: extension part;
116: third side wall; 117: fourth side wall; 118: metal plate; 120: transmission structure;
130: support; 131: first limiting column; 132: second limiting column; 1321: protruding edge; 133: bearing surface;
134: support protrusion; 135: slide rail; 136: first surface; 137: second surface;
140: phase shift medium; and 141: clamping groove.

### DESCRIPTION OF EMBODIMENTS

Terms used in embodiments of this application are only used to explain specific embodiments of this application, but are not intended to limit this application.

Unless otherwise specified in the context, in the entire specification and claims, a term “include (comprise)” and other forms of the term, for example, a third person singular form “includes (comprises)” and a present participle form “including (comprising)” are interpreted as “open and inclusive”, that is, “include, but not limited to”. In descriptions of the specification, terms such as “one embodiment (one embodiment)”, “some embodiments (some embodiments)”, “example embodiments (example embodiments)”, “example (example)”, or “some examples (some examples)” are intended to indicate that specific features, structures, materials, or features related to embodiments or examples are included in at least one embodiment or example of the present disclosure. The foregoing schematic representations of the terms do not necessarily refer to a same embodiment or example. Further, the particular feature, structure, material, or characteristic may be included in any one or more embodiments or examples in any appropriate manner.

In addition, in this application, position terms such as “front” and “back” are defined relative to illustrative positions of components in accompanying drawings. It should be understood that these direction terms are relative concepts and are used for descriptions and clarification of “relative to”, and may vary based on changes of the positions of the components in the accompanying drawings.

The term “and/or” in embodiments of this application describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

An embodiment of this application provides an antenna apparatus, which may be used in a communication device. The communication device may be a communication base station, for example, a public mobile communication base station. The communication device, for example, the communication base station, is an interface device for a mobile device to access the Internet, and is also a form of radio station. In a specific radio coverage area, information may be transferred between the communication base station (mobile communication switching center) and the mobile device.

A main component for information transmission between the communication base station and the mobile device is an antenna system. Generally, as shown in FIG. 1, an antenna system 1 may include an antenna apparatus 10, a fastening bracket 20, a pole 30, a grounding apparatus 40, and the like. The antenna apparatus 10 is fastened to the pole 30 via the fastening bracket 20. In an actual application, a position and a mounting angle of the antenna apparatus 10 on the pole 30 may be adjusted by adjusting a position and an angle of the fastening bracket 20.

In addition, one end of the antenna apparatus 10 may be further connected to the grounding apparatus 40 via a connecting piece, to ensure that the antenna apparatus 10 is grounded. Connector sealing pieces are disposed at one end that is of the connecting piece and that is connected to the antenna apparatus 10 and the other end that is of the connecting piece and that is connected to the grounding apparatus 40, to ensure sealing of connections of the two ends of the connector to the antenna apparatus 10 and the grounding apparatus 40. It may be understood that the connecting sealing piece may be an insulation sealing tape, for example, a polyvinyl chloride (PVC) insulation tape.

In a specific application, the antenna apparatus 10 is generally located in a radome. The radome is a radome structure outside the antenna apparatus 10. The radome is a structural part that protects the antenna apparatus 10 from being affected by an external environment. The radome has a good electromagnetic wave penetration characteristic in electrical performance, and can withstand effect of an external harsh environment in mechanical performance. The antenna apparatus 10 is protected by using the radome, to prevent the antenna apparatus 10 from being damaged due to dust or water.

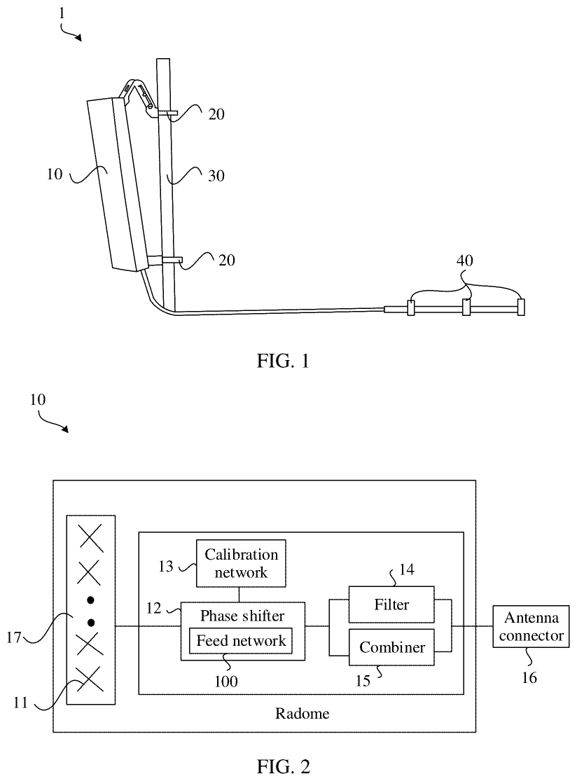

As shown in FIG. 2, the antenna apparatus 10 in embodiments of this application may include at least one independent array including a radiating element 11 and a reflection plate 17. Frequencies of radiating elements 11 may be the same or different. The radiating element 11 is usually placed above the reflection plate 17. The array receives or transmits radio frequency signals via feed network 100 of the array. The antenna apparatus 10 may further include a phase shifter 12 connected to the radiating element 11. The phase shifter 12 is configured to implement real-time change of network coverage, and adjust a signal phase to implement electrical downtilt of an array antenna.

The feed network 100 is disposed in the phase shifter 12, and the feed network 100 is electrically connected to the radiating element 11 and the antenna connector 16. The feed network 100 may feed a radio frequency signal to the radiating element 11 based on a specific amplitude and phase, or send a received radio signal to a signal processing unit of a radio frequency device, for example, a communication base station based on a specific amplitude and phase.

For example, one end that is of the antenna connector 16 and that is away from the feed network may be electrically connected to a radio frequency circuit (not shown in the figure), so that the radio frequency signal is transmitted between the radiating element 11 and the radio frequency circuit. For example, the other end of the antenna connector 16 is electrically connected to a radio frequency signal port in the radio frequency circuit.

When the antenna apparatus is a transmit antenna, the radio frequency circuit may provide a signal source for the antenna apparatus. For example, the other end of the antenna connector 16 may be electrically connected to the radio frequency signal port in the radio frequency circuit, that is, the feed network 100 is electrically connected to the radio frequency signal port in the radio frequency circuit. In this way, the radio frequency signal port may send a radio frequency signal, and feed the radio frequency signal into the radiating element 11 in a form of current. Then, the radiating element 11 sends the radio frequency signal in a form of electromagnetic wave, and the radio frequency signal is received by a receive antenna in a mobile device.

When the antenna apparatus is a receive antenna, the radio frequency circuit may receive a radio frequency signal fed back by the antenna apparatus. For example, the radiating element 11 of the antenna apparatus converts a received electromagnetic wave signal into a current signal, and then transmits the current signal to the radio frequency circuit via the feed network 100, and then the signal processing unit performs subsequent processing.

The radio frequency circuit includes a remote radio unit (RRU), that is, a part of a remote radio unit radio frequency circuit, and the radio frequency signal port is usually disposed in the remote radio unit. For specific circuit settings and a working principle of the radio frequency circuit, directly refer to related content in a conventional technology. Details are not described herein.

During an actual application, with wide application and development of the 5G technology, a base station antenna develops toward multi-band and multi-array configuration, and integration of the antenna apparatus is increasingly high. For example, the antenna apparatus may include a plurality of radiating elements 11 and a plurality of feed networks 100, and the feed networks 100 and the radiating elements 11 are disposed in a one-to-one correspondence, so that the antenna apparatus forms an array antenna. Each radiating element 11 is electrically connected to a feed network 100 corresponding to the radiating element 11, so that each radiating element 11 is electrically connected to the radio frequency circuit via the respective feed network 100, and each radiating element 11 receives or sends a radio frequency signal.

In addition, in some embodiments, the feed network 100 may be further connected to a drive component (not shown in the figure), to implement different radiation beam directions; or the feed network 100 may be further connected to a calibration network, to obtain a calibration signal required by a system. In addition, a module like a combiner 15 or a filter 14 configured to expand performance may be further disposed between the feed network 100 and the antenna connector 16, to improve performance of the antenna apparatus 10. The phase shifter 12, the filter 14, the calibration network 13, and the combiner 15 are not further limited in embodiments of this application.

With reference to the accompanying drawings, the following describes in detail the feed network 100 provided in embodiments of this application.

For ease of description, in embodiments of this application, a first direction is a thickness direction of the feed network 100, and is a z direction in the figure; a second direction is a length direction of the feed network 100, is also a sliding direction of a phase shift medium, and is a y direction in the figure; and a third direction is a width direction of the feed network 100, and is an x direction in the figure.

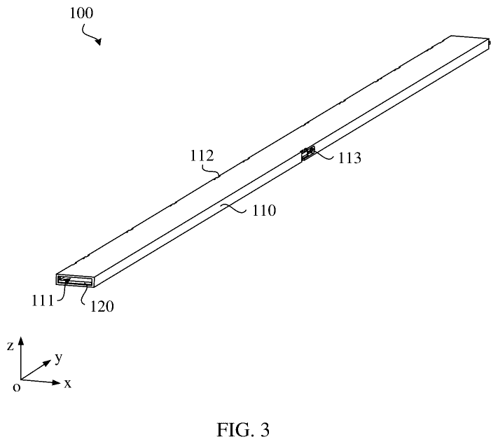

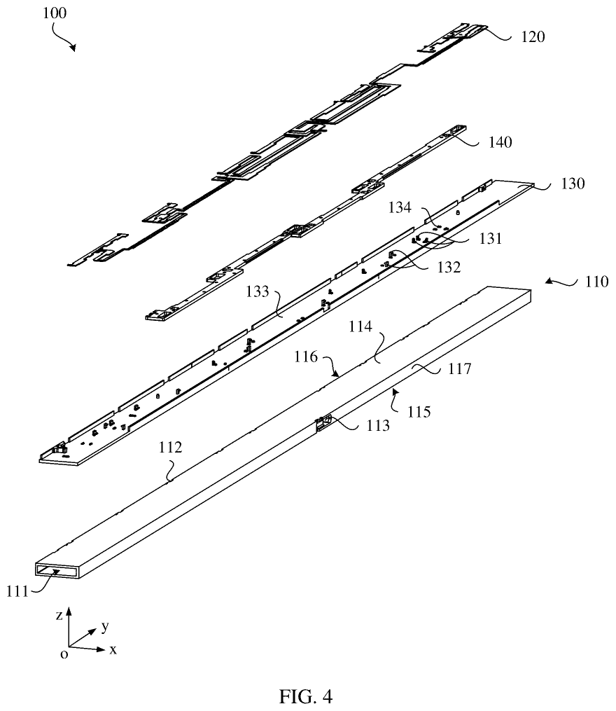

As shown in FIG. 3 and FIG. 4, an embodiment of this application further provides the feed network 100. The feed network 100 may include a housing 110. At least one accommodation cavity 111 is disposed in the housing 110. A transmission structure 120, a support 130, and a phase shift medium 140 are disposed in each accommodation cavity 111. For example, the support 130 is located in the accommodation cavity 111, and the support 130 is connected to at least one inner wall of the accommodation cavity 111, so that the support 130 can be fastened into the accommodation cavity 111, to prevent the support 130 from shifting. For example, the support 130 is connected to a side that is of a second side wall 115 and that faces the accommodation cavity 111. Inner walls of the accommodation cavity 111 are inner walls that are of the housing 110 and that face the accommodation cavity 111, namely, surfaces that are of a first side wall 114, the second side wall 115, a third side wall 116, and a fourth side wall 117 and that face the accommodation cavity 111.

Certainly, in another embodiment, the support 130 may alternatively be connected to another inner wall of the accommodation cavity 111. For example, the support 130 may be connected to at least one of the first side wall 114, the second side wall 115, the third side wall 116, and the fourth side wall 117. For example, the support 130 may be connected to all of the first side wall 114, the second side wall 115, the third side wall 116, and the fourth side wall 117. The support 130 may be connected to the first side wall 114, the support 130 may be connected to the second side wall 115, the support 130 may be connected to both the first side wall 114 and the second side wall 115, and the support 130 may be connected to both the third side wall 116 and the fourth side wall 117. A connection position between the support 130 and the accommodation cavity 111 is not further limited.

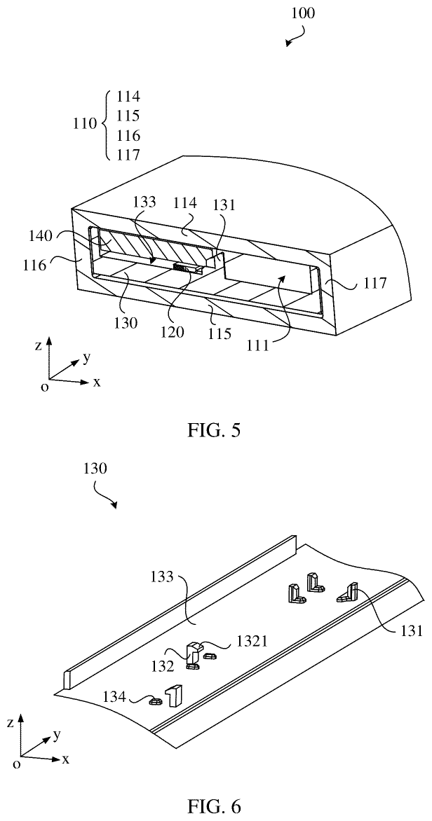

Refer to FIG. 4 and FIG. 5. In the z direction, the support 130 includes a bearing surface 133. The bearing surface 133 and an inner wall that is of the accommodation cavity 111 and that is opposite to the bearing surface 133 are spaced apart, and the transmission structure 120 is disposed on a surface of the bearing surface 133. In the z direction, the phase shift medium 140 is disposed between the transmission structure 120 and one of the inner walls of the accommodation cavity 111, and the phase shift medium 140 is slidably connected to the support 130 in the y direction. The z direction is the thickness direction of the feed network 100, and the y direction is a sliding direction of the phase shift medium 140, namely, the length direction of the feed network 100. The first direction is perpendicular to the second direction.

According to the feed network 100 provided in this embodiment of this application, the at least one accommodation cavity 111 is disposed in the housing 110, and the transmission structure 120, the support 130, and the phase shift medium 140 are disposed in each accommodation cavity 111, so that different accommodation cavities 111 can be connected to radiating elements that are with different polarizations and that are of the antenna apparatus.

The support 130 is disposed, and the bearing surface 133 is disposed on the support 130, so that the support 130 can provide mounting positions for the transmission structure 120 and the phase shift medium 140. A distance between the transmission structure 120 and the accommodation cavity 111 can be further adjusted by adjusting a position of the bearing surface 133 in the z direction. This improves design flexibility of the feed network 100. In addition, the support 130 can be disposed to improve consistency of indicators of the feed network 100, and reduce fluctuations of the indicators.

The phase shift medium 140 is slidably connected to the support 130 in the y direction, so that the feed network 100 can adapt to different working requirements, to improve applicability of the feed network 100. The phase shift medium 140 is disposed between the transmission structure 120 and the one of the inner walls of the accommodation cavity 111, so that in comparison with a technical solution in which phase shift media 140 are disposed on both sides of the transmission structure 120 in a related technology, in the technical solution in this embodiment of this application, fewer phase shift media 140 are disposed, thereby simplifying a structure of the feed network 100 and reducing costs.

In some embodiments, the housing 110 may be an integrated structure. As shown in FIG. 5, the housing 110 may include the first side wall 114, the second side wall 115, the third side wall 116, and the fourth side wall 117. In the z direction, the first side wall 114 and the second side wall 115 are disposed opposite to each other, and in the x direction, the third side wall 116 and the fourth side wall 117 are disposed opposite to each other. One end of the third side wall 116 is connected to the first side wall 114, and the other end is connected to the second side wall 115; and one end of the fourth side wall 117 is connected to the first side wall 114, and the other end is connected to the second side wall 115. In this way, the first side wall 114, the second side wall 115, the third side wall 116, and the fourth side wall 117 enclose the accommodation cavity 111.

In this embodiment, the support 130 is disposed in the accommodation cavity 111, the support 130 is fastened into the accommodation cavity 111, and the support 130 is connected to all of the first side wall 114, the second side wall 115, the third side wall 116, and the fourth side wall 117. For example, a connection manner between the support 130, and the first side wall 114, the second side wall 115, the third side wall 116, and the fourth side wall 117 may be abutting, clamping, or bonding. The connection manner between the support 130, and the first side wall 114, the second side wall 115, the third side wall 116, and the fourth side wall 117 is not further limited in this embodiment provided that the support 130 can be fastened into the accommodation cavity 111.

The housing 110 is disposed as the integrated structure, so that the first side wall 114, the second side wall 115, the third side wall 116, and the fourth side wall 117 may be connected to enclose the housing 110, and the accommodation cavity 111 is formed in the housing 110. The first side wall 114, the second side wall 115, the third side wall 116, and the fourth side wall 117 can be configured to accommodate the transmission structure 120, the phase shift medium 140, and the support 130, and can be further configured to protect the transmission structure 120, the phase shift medium 140, and the support 130. The housing 110 is disposed as the integrated structure to facilitate production.

In this embodiment, with reference to FIG. 4 and FIG. 5, a side that is of the support 130 and that faces the second side wall 115 abuts against the second side wall 115, a side that is of the support 130 and that faces the first side wall 114 extends in the z direction to be close to the second side wall 115, and a side that is of the support 130 and that is close to the first side wall 114 is the bearing surface 133. As shown in FIG. 6, support protrusions 134 configured to support the phase shift medium 140, and a first limiting column 131 and a second limiting column 132 that are configured to limit a position of the phase shift medium 140 are further disposed on the bearing surface 133. For example, the phase shift medium 140 may be disposed at the tops of the support protrusions 134, where there are a plurality of support protrusions 134, and the plurality of support protrusions 134 are spaced apart on the bearing surface 133. In this embodiment, positions for disposing the support protrusions 134 are not further limited. The support protrusions 134 are disposed, so that a contact area between the phase shift medium 140 and the bearing surface 133 can be reduced, friction force between the phase shift medium 140 and the bearing surface 133 can be reduced, and the phase shift medium 140 can move on the support 130 more easily. Therefore, the feed network 100 can process radio frequency signals of different frequencies.

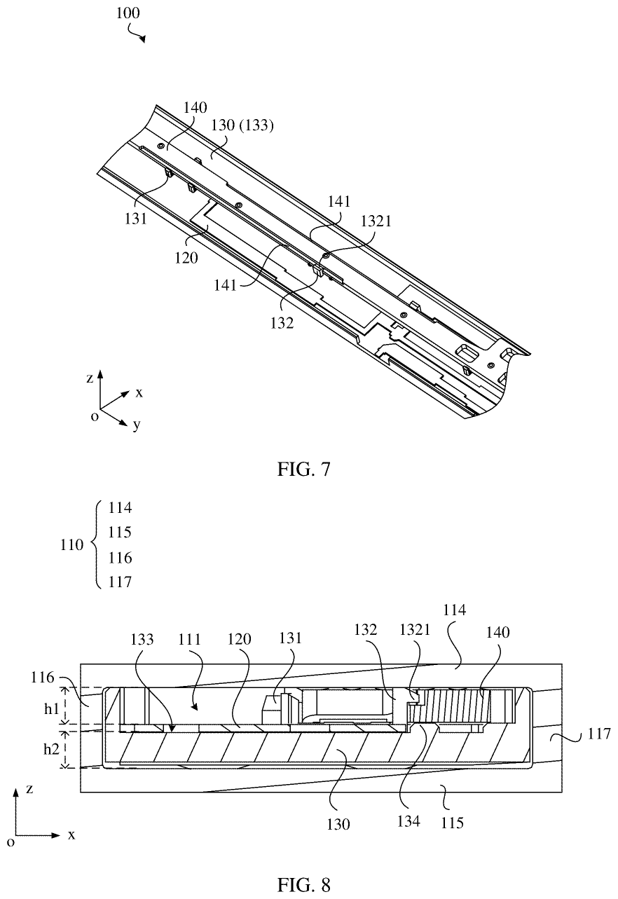

With reference to FIG. 4, FIG. 6, and FIG. 7, a plurality of first limiting columns 131 and a plurality of second limiting columns 132 may exist, where the plurality of first limiting columns 131 are disposed on two sides of the phase shift medium 140 in the x direction, and the plurality of second limiting columns 132 are disposed on the two sides of the phase shift medium 140 in the x direction. In addition, in the y direction, the plurality of first limiting columns 131 are spaced apart on the bearing surface 133, and the plurality of second limiting columns 132 are spaced apart on the bearing surface 133. In this embodiment of this application, a quantity of first limiting columns 131 and a quantity of second limiting columns 132 may be determined based on a length of the feed network 100 in the y direction. Therefore, the quantity of first limiting columns 131 and the quantity of second limiting columns 132 are not further limited in embodiments of this application.

In a possible implementation, the support 130 may further include a slide rail 135 (not shown in the figure). The slide rail 135 extends in the y direction, the phase shift medium 140 is slidably disposed in the slide rail 135, and the slide rail 135 is configured to support the phase shift medium 140, and is configured to enable the phase shift medium 140 to slide in the y direction. For example, in this embodiment, the slide rail 135 is formed between the plurality of first limiting columns 131 and the plurality of second limiting columns 132. The first limiting column 131 may be a columnar structure disposed in the z direction, and the first limiting column 131 may limit the phase shift medium 140 to move in the x direction, to prevent the phase shift medium 140 from shaking relative to the support 130, and improve stability of the feed network 100.

As shown in FIG. 6, the second limiting column may include a columnar structure extending in the z direction, and a protruding edge 1321 extending in the x direction to be close to the phase shift medium 140. The protruding edge 1321 may be configured to limit the phase shift medium 140 to move in the x direction, and may be further configured to limit the phase shift medium 140 to move in the y direction, to prevent the phase shift medium 140 from being detached from the accommodation cavity 111 in the y direction.

As shown in FIG. 7, the phase shift medium 140 is disposed between the first limiting column 131 and the second limiting column 132 of the support 130, that is, disposed on the slide rail 135 of the support 130. A clamping groove 141 connected to the second limiting column 132 is disposed on the phase shift medium 140, and the protruding edge 1321 of the second limiting column 132 is clamped and connected to the clamping groove 141. The phase shift medium 140 may move relative to the second limiting column 132 in the y direction, and when a side wall of the clamping groove 141 in the y direction abuts against a side wall of the protruding edge 1321 on the second limiting column 132 in the y direction, the phase shift medium 140 is clamped relative to the second limiting column 132, to limit the phase shift medium 140 to move in the y direction.

The protruding edge 1321 is disposed on the second limiting column 132 and the clamping groove 141 is disposed on the phase shift medium 140, so that the phase shift medium 140 may move in the fastened slide rail 135 on the support 130, the phase shift medium 140 may slide on the support 130, and the slide rail 135 may limit travel of the phase shift medium 140. This ensures working accuracy of the feed network 100.

In a possible implementation, a first gap h1 exists between one of the first side wall 114 and the second side wall 115 and the transmission structure 120, and a second gap h2 exists between the other one of the first side wall 114 and the second side wall 115 and the transmission structure 120. The first gap h1 is greater than or equal to the second gap h2. For example, as shown in FIG. 8, the first gap h1 exists between the first side wall 114 and the transmission structure 120, the second gap h2 exists between the second side wall 115 and the transmission structure 120, and the first gap h1 is greater than or equal to the second gap h2.

The first gap h1 and the second gap h2 are disposed to provide disposing space for the phase shift medium 140. The first gap h1 is disposed to be greater than or equal to the second gap h2, so that the transmission structure may be located at different positions between the first side wall 114 and the second side wall 115. This improves the design flexibility of the feed network 100.

In a possible implementation, in the z direction, the first gap h1 is equal to the second gap h2. The phase shift medium 140 is located in the first gap h1 or the second gap h2. For example, as shown in FIG. 8, the first gap h1 is equal to the second gap h2, and the phase shift medium 140 is located in the first gap h1. Certainly, in another embodiment, when the first gap h1 is equal to the second gap h2, the phase shift medium 140 may also be disposed in the first gap h1. In a case in which the first gap h1 is equal to the second gap h2, a disposition position of the phase shift medium 140 is not further limited.

The first gap h1 is disposed to be equal to the second gap h2, so that the first side wall 114 and the second side wall 115 can be symmetrically disposed relative to the transmission structure 120 in the first direction, that is, distances from the transmission structure 120 to the first side wall 114 and to the second side wall 115 are equal. Therefore, the phase shift medium 140 can be disposed in the first gap h1 or the second gap h2. This improves the design flexibility of the phase shift medium 140 and improves the applicability of the feed network 100.

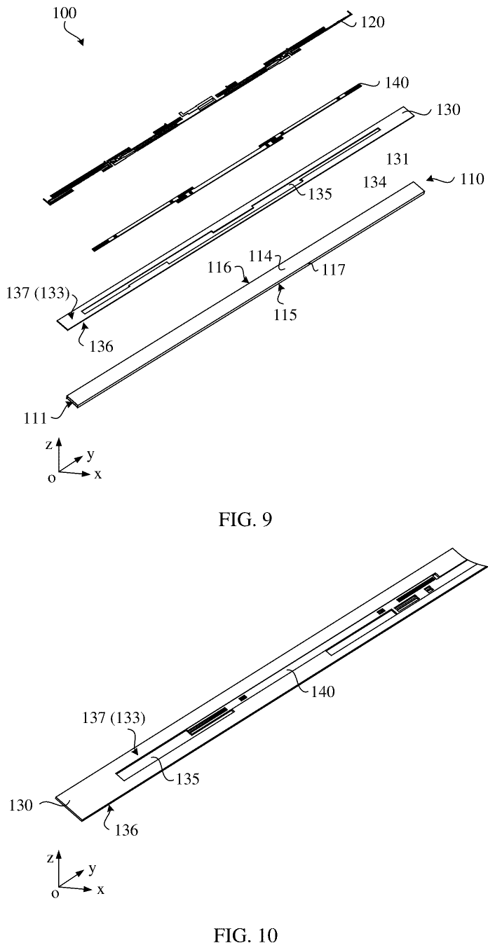

In embodiments of this application, a structure of the support 130 may be alternatively in another form. As shown in FIG. 9, in this embodiment, the feed network 100 may include a housing 110, an accommodation cavity 111 is disposed in the housing 110, and a transmission structure 120, a support 130, and a phase shift medium 140 are disposed in the accommodation cavity 111. The support 130 is disposed in the accommodation cavity 111, the transmission structure 120 is disposed on a bearing surface 133 of the support 130, and the phase shift medium 140 is disposed on the support 130.

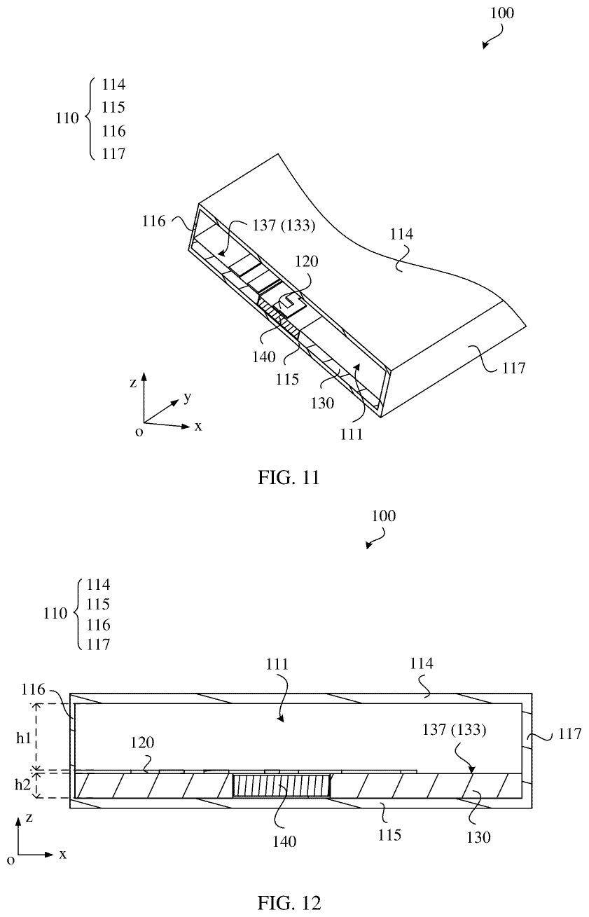

As shown in FIG. 10 and FIG. 11, in this embodiment, the support 130 may be of a plate-like structure. The support 130 includes a first surface 136 and a second surface 137, and the first surface 136 and the second surface 137 are disposed away from each other. The first surface 136 is connected to one of the first side wall 114 and the second side wall 115, and the second surface 137 is disposed opposite to the other one of the first side wall 114 and the second side wall 115. The transmission structure 120 is disposed on the second surface 137, and the second surface 137 is the bearing surface 133. The support 130 is disposed as the plate-like structure, so that a structure of the support 130 can be simplified, costs can be reduced, and mounting is convenient.

As shown in FIG. 10, the first surface 136 is connected to the second side wall 115, the second surface 137 and the first side wall 114 are disposed opposite to each other, and the transmission structure 120 is disposed on the second surface 137. In this embodiment, a slide rail 135 is disposed on the support 130, and an orthographic projection of the phase shift medium 140 in the y direction is located in an orthographic projection of the support 130 in the y direction.

In other words, the phase shift medium 140 is nested in the support 130, so that space occupied by the support 130 and the phase shift medium 140 partially overlaps, that is, the phase shift medium 140 is disposed in the space occupied by the support 130. In comparison with disposing the phase shift medium 140 on a surface of the support 130, this can reduce space occupied by the phase shift medium 140 and the support 130 in the z direction. Therefore, the support 130 and the phase shift medium 140 can be disposed in a small accommodation cavity 111, and thickness of the support 130 and the phase shift medium 140 in the z direction can be reduced. Further, costs are reduced, a height of the housing 110 of the feed network 100 in the z direction can be further reduced, and miniaturization development of the feed network 100 is facilitated.

It should be noted that, in this embodiment, specific thickness of the phase shift medium 140 and the support 130 in the z direction is not further limited, and may be specifically set based on a specific situation.

In some embodiments, as shown in FIG. 10, the slide rail 135 is of a groove-shaped structure provided on the support 130, and the phase shift medium 140 is slidably disposed in the groove-shaped structure. A length of the groove-shaped structure in the z direction is greater than a length of the phase shift medium 140 in the z direction, so that there is sliding space for the phase shift medium 140, and the phase shift medium 140 can slide in the groove-shaped structure. The groove-shaped structure may limit a sliding track and travel of the phase shift medium 140.

It should be noted that, a shape of the slide rail 135 may be disposed based on a shape of the phase shift medium 140. Therefore, the shape of the slide rail 135 is not further limited in this embodiment.

As shown in FIG. 11, the support 130 is located in the accommodation cavity 111, and the first surface 136 of the support 130 is connected to the second side wall 115, so that the support 130 can be fastened into the accommodation cavity 111, to prevent the support 130 from shifting. A gap exists between the second surface 137 of the support 130 and a side that is of the first side wall 114 and that faces the accommodation cavity 111. The transmission structure 120 is disposed on the second surface 137, and the phase shift medium 140 is nested in the support 130.

In a possible implementation, as shown in FIG. 12, in the z direction, a distance between the first surface 136 and the second surface 137 is smaller than a distance between the second surface 137 and the other one of the first side wall 114 and the second side wall 115. For example, the distance between the first surface 136 and the second surface 137 is smaller than a distance between the second surface 137 and the first side wall 114. In this embodiment, the distance between the first surface 136 and the second surface 137 is the second gap h2, the distance between the second surface 137 and the first side wall 114 is the first gap h1, and the second gap h2 is smaller than the first gap h1. The phase shift medium 140 is disposed in the second gap h2 (nested in the support 130), the transmission structure 120 is disposed on the second surface 137, and the second surface 137 is the bearing surface 133.

Because the second gap h2 is smaller than the first gap h1, both the transmission structure 120 and the phase shift medium 140 are close to the second side wall 115 of the accommodation cavity 111. Certainly, in another embodiment, the transmission structure 120 and the phase shift medium 140 may alternatively be close to the first side wall 114 of the accommodation cavity 111. In other words, the transmission structure 120 is biased toward one of the first side wall 114 or the second side wall 115. In this way, energy on a side wall that is of the housing 110 and that is close to the phase shift medium 140 and the transmission structure 120 can be increased, thereby improving working efficiency of the feed network 100.

In other words, the first gap h1 is disposed to be greater than the second gap h2, and the transmission structure 120 is disposed in the second gap h2, that is, the transmission structure 120 is disposed in a small gap, so that the transmission structure 120 can be closer to one of inner walls (the first side wall 114 or the second side wall 115) of the accommodation cavity 111. In this way, a distance between the transmission structure 120 and an inner wall that is of the accommodation cavity 111 and that is opposite to the transmission structure 120 can be reduced, energy on the inner wall that is of the accommodation cavity 111 and that is opposite to the transmission structure 120 can be increased, and working efficiency of the feed network 100 can be improved.

The phase shift medium 140 is disposed in the second gap, that is, the phase shift medium 140 is disposed in the small gap, so that the phase shift medium 140 and the support 130 may share a part of space in the z direction. In this way, thickness of the phase shift medium 140 and the support 130 in the z direction can be reduced, thereby reducing costs.

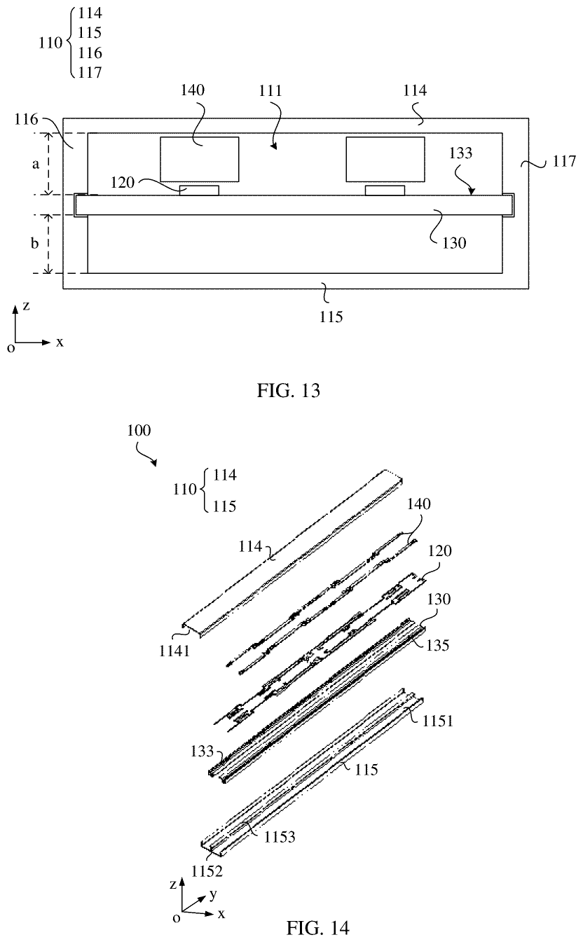

Certainly, in another embodiment, the support 130 may alternatively be disposed at another position. As shown in FIG. 13, the support 130 is alternatively of a plate-like structure. In the x direction, two ends of the support 130 are respectively connected to inner walls of the accommodation cavity 111, and a distance a between the support 130 and the first side wall 114 and a distance b between the support 130 and the second side wall 115 are both greater than 0. A quantity relationship between a and b is not further limited in embodiments of this application, and may be specifically set based on a specific situation.

The transmission structure 120 is disposed on a side that is of the support 130 and that faces the first side wall 114, and the phase shift medium 140 is disposed between the transmission structure 120 and the first side wall 114. For example, grooves for accommodating the support 130 are disposed on the third side wall 116 and the fourth side wall 117 of the feed network 100, so that the support 130 can be stably disposed in the housing 110.

The two ends of the support 130 are respectively connected to the inner walls of the accommodation cavity 111 in the x direction, so that stability of the support 130 can be improved, and large disposition space can be provided for the phase shift medium 140 and the transmission structure 120. In addition, when disposition space required by the phase shift medium 140 and the transmission structure 120 is the same, a size of the accommodation cavity 111 can be reduced. This facilitates miniaturization development of the feed network 100.

In this embodiment, the support 130 may be a circuit board. In this way, no additional circuit board needs to be disposed, thereby simplifying a structure of the feed network 100 and reducing costs.

Certainly, in another embodiment, the support 130 may alternatively be disposed to be another structure based on a specific requirement. For example, the support 130 may also alternatively a three-dimensional plastic part (referring to FIG. 4 and FIG. 14). A specific structure of the support 130 is not further limited in this embodiment.

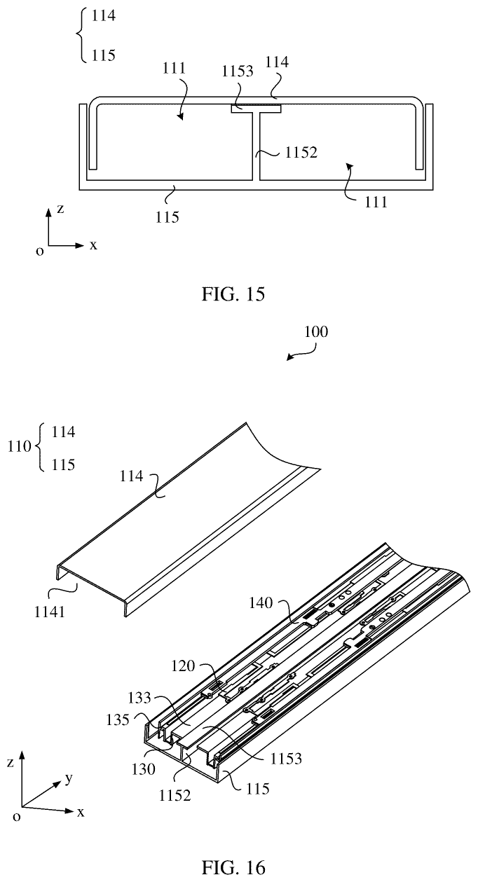

The housing 110 of the feed network 100 in the foregoing embodiment is of the integrated structure. Certainly, in another embodiment, the housing 110 may alternatively be a structure in another form. As shown in FIG. 14 and FIG. 15, the feed network 100 includes a housing 110, a transmission structure 120, a support 130, and a phase shift medium 140. Alternatively, the housing 110 may be of a split structure. For example, both the first side wall 114 and the second side wall 115 may be of “U”-shaped structures. In a z direction, the first side wall 114 includes a first opening 1141, and the second side wall 115 includes a second opening 1151. The first opening 1141 and the second opening 1151 are disposed opposite to each other, orthographic projections of the first side wall 114 and the second side wall 115 in the z direction at least partially overlap, orthographic projections of the first side wall 114 and the second side wall 115 in an x direction at least partially overlap, and the x direction is perpendicular to both the z direction and a y direction. In the x direction, partial structures that are of the first side wall 114 and the second side wall 115 and that are opposite to each other are coupled to each other. For example, that the partial structures that are of the first side wall 114 and the second side wall 115 and that are opposite to each other are coupled to each other may include: side walls located on two sides of an opening of the “U”-shaped structure are coupled to each other. For example, side walls on two sides of the first opening 1141 of the first side wall 114 are coupled to side walls on two sides of the second opening 1151 of the second side wall 115.

The housing 110 is disposed as the split structure, the first side wall 114 and the second side wall 115 are disposed as the “U”-shaped structures, the first opening 1141 and the second opening 1151 are disposed opposite to each other, and in the x direction, the partial structures that are of the first side wall 114 and the second side wall 115 and that are opposite to each other are coupled to each other, so that the accommodation cavity 111 is formed between the first side wall 114 and the second side wall 115. In addition, the “U”-shaped structure is easy to process, processing costs are low, and costs of the feed network 100 can be further reduced.

In a possible implementation, at least one convex wall 1152 is disposed between the first side wall 114 and the second side wall 115. The at least one convex wall 1152 is spaced apart in the x direction, to form a plurality of accommodation cavities 111 between the first side wall 114, the second side wall 115, and the convex wall 1152. For example, the transmission structure 120, the support 130, and the phase shift medium 140 may be disposed in each accommodation cavity 111.

It should be noted that, transmission structures 120 in different accommodation cavities 111 may be different, so that different accommodation cavities 111 can feed radiating elements with different polarizations. In this way, one feed network 100 can meet requirements of the radiating elements with different polarizations, thereby simplifying a structure of the feed network 100 and reducing costs.

In a possible implementation, a first end of the convex wall 1152 is fastened to one of the first side wall 114 and the second side wall 115; a second end of the convex wall 1152 extends in the z direction to be close to the other one of the first side wall 114 and the second side wall 115; and the second end of the convex wall 1152 is coupled to the other one of the first side wall 114 and the second side wall 115.

For example, the first end of the convex wall 1152 is fastened to the second side wall 115, the second end of the convex wall 1152 extends in the z direction to be close to the first side wall 114, and the second end of the convex wall 1152 is coupled to the first side wall 114. In some embodiments, an extension part 1153 may be disposed at the second end of the convex wall 1152. The extension part 1153 extends in the x direction, and the extension part 1153 is coupled to the first side wall 114.

The first end of the convex wall 1152 is fastened to the second side wall 115, and the second end of the convex wall 1152 is coupled to the first side wall 114, so that two accommodation cavities 111 may be formed on two sides of the convex wall 1152 in the x direction, and no interference is generated between signals of transmission structures 120 located in the two accommodation cavities 111. The extension part 1153 is disposed, so that a relative area between the convex wall 1152 and the first side wall 114 may be increased, thereby improving coupling efficiency between the convex wall 1152 and the first side wall 114, and ensuring that each accommodation cavity 111 can work normally.

It should be noted that there may be one, two, three, four, or more convex walls 1152. A quantity of convex walls 1152 is not limited in embodiments of this application. In addition, a position of the convex wall 1152 disposed in the x direction and a distance between two adjacent convex walls 1152 are not limited in this embodiment. For example, when there is one convex wall 1152, the convex wall 1152 may be disposed in a central position between the first side wall 114 and the second side wall 115 in the x direction, so that volumes of two accommodation cavities 111 are the same, and the feed network 100 is a symmetric structure. This provides industrial aesthetics and facilitates processing. Certainly, in some embodiments, the convex wall 1152 may also be disposed in the x direction on a side deviating from the central position. In this way, the volumes of the two accommodation cavities 111 may be different, so that the two accommodation cavities 111 can adapt to different transmission structures 120, thereby improving applicability of the feed network 100. Therefore, in embodiments of this application, a quantity of convex walls 1152 and a disposing position of the convex wall 1152 are not further limited.

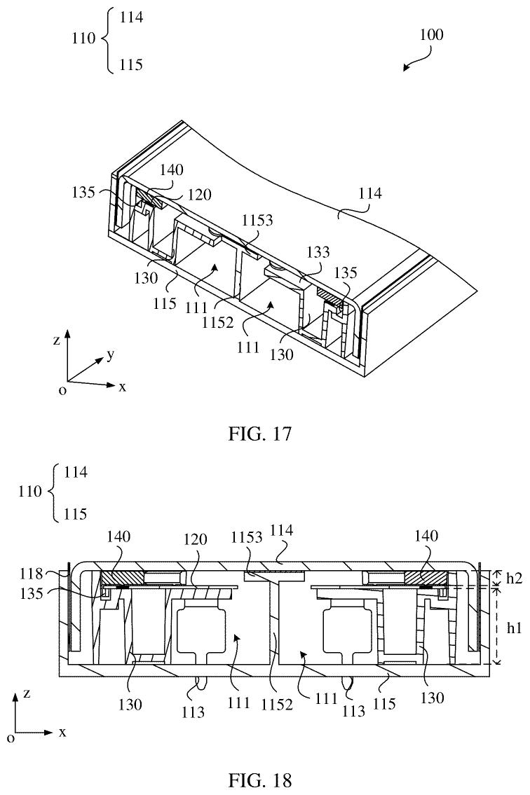

In this embodiment, as shown in FIG. 16, FIG. 17, and FIG. 18, the housing 110 of the feed network 100 may be enclosed into two accommodation cavities 111, and the support 130, the phase shift medium 140, and the transmission structure 120 are disposed in each accommodation cavity 111. In the z direction, one end of the support 130 is connected to the first side wall 114, and the other end of the support 130 is connected to the second side wall 115. In other words, the support 130 is fastened between the first side wall 114 and the second side wall 115. A connection manner between the support 130 and the first side wall 114 and the second side wall 115 may be a clamping connection, an abutting connection, or bonding. The connection manner between the support 130 and the first side wall 114 and the second side wall 115 is not further limited.

One end of the support 130 is connected to the first side wall 114, and the other end of the support 130 is connected to the second side wall 115, so that stability of the support 130 can be improved. Certainly, in another embodiment, the support 130 may be connected to side walls in all directions in the accommodation cavity 111. For example, the support 130 may be connected to all of the first side wall 114, the second side wall 115, the third side wall 116, and the fourth side wall 117. In this way, stability of the support 130 in the accommodation cavity 111 can be improved.

A bearing surface 133 is disposed on a side that is of the support 130 and that is close to the first side wall 114, the transmission structure 120 is disposed on the bearing surface 133, and a slide rail 135 is disposed on the support 130. A partial structure of the phase shift medium 140 is disposed in the slide rail 135, so that the phase shift medium 140 may slide relative to the support 130. In this embodiment, the slide rail 135 may be of a groove-shaped structure that is concave from the bearing surface 133 in the z direction to the second side wall 115. The groove-shaped structure is easy to dispose, and can reduce processing costs. Certainly, in another embodiment, the slide rail 135 may alternatively be disposed to another structure. In this embodiment, a specific shape of the slide rail 135 is not further limited.

In a possible implementation, each housing 110 includes a first cable outlet interface 112 and a second cable outlet interface 113. A partial structure of the transmission structure 120 is located in the first cable outlet interface 112, and the first cable outlet interface 112 is configured to connect to a radiating element of an antenna. A partial structure of the transmission structure 120 is located in the second cable outlet interface 113, and the second cable outlet interface 113 is configured to connect to an antenna connector.

As shown in FIG. 18, the transmission structure 120 is disposed in each accommodation cavity 111, and each transmission structure 120 corresponds to the first cable outlet interface 112 (not shown in the figure) and the second cable outlet interface 113. A partial structure of the transmission structure 120 may extend from the first cable outlet interface 112 and the second cable outlet interface 113, to connect to a corresponding component. In this embodiment, disposition positions and disposition quantities of the first cable outlet interface 112 and the second cable outlet interface 113 are not further limited, and may be specifically set based on a specific situation.

In addition, a metal plate 118 configured to improve coupling efficiency may be further disposed between coupling connection parts of the first side wall 114 and the second side wall 115. The metal plate 118 may increase a relative area between the first side wall 114 and the second side wall 115, and reduce a gap between the first side wall 114 and the second side wall 115, thereby improving coupling efficiency.

It should be noted that a first gap h1 exists between one of the first side wall 114 and the second side wall 115 and the transmission structure 120, and a second gap h2 exists between the other one of the first side wall 114 and the second side wall 115 and the transmission structure 120. The first gap h1 is greater than or equal to the second gap h2. As shown in FIG. 18, a gap between the first side wall 114 and the transmission structure 120 is greater than a gap between the second side wall 115 and the transmission structure 120. In other words, in this embodiment, the first gap h1 exists between the second side wall 115 and the transmission structure 120, the second gap h2 exists between the first side wall 114 and the transmission structure 120, the first gap h1 is greater than the second gap h2, and the phase shift medium is disposed in the second gap h2.

Because the second gap h2 is smaller than the first gap h1, both the transmission structure 120 and the phase shift medium 140 are close to the first side wall 114 of the accommodation cavity 111, that is, the transmission structure 120 is biased toward the first side wall 114. In this way, energy on the first side wall 114 that is of the housing 110 and that is close to the phase shift medium 140 and the transmission structure 120 can be increased, thereby improving working efficiency of the feed network 100.

It should be noted that the second gap h2 and the first gap h1 may be changed based on a shape of the support, and may be specifically disposed based on a specific situation. In this embodiment, the second gap h2 and the first gap h1 are not further limited.

It should be noted that, in embodiments of this application, a connection manner of the transmission structure 120 and the support 130 is not limited. The transmission structure 120 may be fastened to the support 130 in a manner of clamping, bonding, heat fusion, or the like, or may be fastened to the support 130 in another manner. In addition, the housing 110 in embodiments of this application is made of a metal material, and the accommodation cavity is a metal accommodation cavity. A specific material of the housing 110 is not further limited in this embodiment.

It should be noted that according to the phase shifter provided in embodiments of this application, the foregoing feed network 100 is disposed, so that a structure can be simplified, and costs can be reduced. According to the antenna apparatus in embodiments of this application, the feed network 100 in the first aspect is disposed, so that a structure of the antenna apparatus can be simplified, thereby reducing costs of the antenna apparatus.

It should be understood that, in this application, “electrical connection” may be understood that components contact physically and conduct electrically, or may be a coupled connection. It may also be understood as a form in which different components in a line structure are connected through physical lines that can transmit an electrical signal, such as a printed circuit board (printed circuit board, PCB) copper foil or a conducting wire. “Coupling” may be understood as conducting electrically through air in an indirect coupling manner. The coupling in this application may be understood as capacitive coupling. For example, an equivalent capacitor is formed by coupling between gaps of two electric-conductors, to implement signal transmission. A person skilled in the art may understand that a coupling phenomenon is a phenomenon that inputs and outputs of two or more circuit elements or electrical networks closely cooperate with each other and affect each other, and energy is transmitted from one side to the other side through interaction. A “communication connection” may refer to an electrical signal transmission, including a wireless communication connection and a wired communication connection. The wireless communication connection does not require a physical medium and does not belong to a connection relationship that defines a construction of a product. Both “connection” and “being connected to” may refer to a mechanical connection relationship or a physical connection relationship, that is, a connection between A and B or that A is connected to B may mean that there is a fastening component (like a screw, a bolt, or a rivet) between A and B, or A and B are in contact with each other and A and B are difficult to be separated. Opposite/disposed opposite to each other: That A is disposed opposite to B may mean that A and B are disposed opposite to each other or face to face (opposite to, or face to face).

In the description of embodiments of this application, it should be noted that, unless otherwise explicitly stipulated and restricted, terms “mounting”, “joint connection”, and “connection” should be understood broadly, which, for example, may be a fixed connection, or may be an indirect connection by using a medium, or may be an internal communication between two components, or may be an interactive relationship between two components. A person of ordinary skill in the art may understand specific meanings of the foregoing terms in embodiments of this application based on specific cases.

In the specification, claims, and accompanying drawings of embodiments of this application, the terms “first”, “second”, “third”, “fourth”, and the like (if existent) are intended to distinguish between similar objects but do not necessarily indicate a specific order or sequence.

1. A feed network, comprising a housing, wherein at least one accommodation cavity is disposed in the housing;
a transmission structure, a support, and a phase shift medium are disposed in each accommodation cavity;
the support is located in the accommodation cavity, and the support is connected to at least one inner wall of the accommodation cavity;
in a first direction, the support comprises a bearing surface, an inner wall that is of the accommodation cavity and that is opposite to the bearing surface and the bearing surface are spaced apart, and the transmission structure is disposed on a surface of the bearing surface;
in the first direction, the phase shift medium is disposed between the transmission structure and one of inner walls of the accommodation cavity, and the phase shift medium is slidably connected to the support in a second direction; and
the first direction is a thickness direction of the feed network, the second direction is a sliding direction of the phase shift medium, and the first direction is perpendicular to the second direction.

2. The feed network according to claim 1, wherein the housing comprises a first side wall and a second side wall;
in the first direction, the first side wall and the second side wall are disposed opposite to each other, a first gap exists between one of the first side wall and the second side wall and the transmission structure, and a second gap exists between the other one of the first side wall and the second side wall and the transmission structure; and
the first gap is larger than or equal to the second gap.

3. The feed network according to claim 2, wherein in the first direction, the first gap is larger than the second gap; and
the phase shift medium is located in the second gap.

4. The feed network according to claim 2, wherein in the first direction, the first gap is equal to the second gap; and
the phase shift medium is located in the first gap or the second gap.

5. The feed network according to claim 2, wherein the housing is of an integrated structure;
the housing further comprises a third side wall and a fourth side wall;
in a third direction, the third side wall and the fourth side wall are disposed opposite to each other;
one end of the third side wall is connected to the first side wall, and the other end is connected to the second side wall;
one end of the fourth side wall is connected to the first side wall, and the other end is connected to the second side wall; and
the third direction is perpendicular to both the first direction and the second direction.

6. The feed network according to claim 2, wherein the housing is of a split structure;
both the first side wall and the second side wall are of “U”-shaped structures;
in the first direction, the first side wall comprises a first opening, and the second side wall comprises a second opening;
the first opening and the second opening are disposed opposite to each other, orthographic projections of the first side wall and the second side wall in the first direction at least partially overlap, orthographic projections of the first side wall and the second side wall in a third direction at least partially overlap, and the third direction is perpendicular to both the first direction and the second direction; and
in the third direction, partial structures that are of the first side wall and the second side wall and that are opposite to each other are coupled to each other.

7. The feed network according to claim 6, wherein at least one convex wall is disposed between the first side wall and the second side wall;
the at least one convex wall is spaced apart in the third direction, to form a plurality of accommodation cavities between the first side wall, the second side wall, and the convex wall; and
the transmission structure, the support, and the phase shift medium are disposed in each accommodation cavity.

8. The feed network according to claim 7, wherein a first end of the convex wall is fastened to one of the first side wall and the second side wall; and
a second end of the convex wall extends in the first direction to be close to the other one of the first side wall and the second side wall, and the second end of the convex wall is coupled to the other one of the first side wall and the second side wall.

9. The feed network according to claim 7, wherein an extension part is disposed at the second end of the convex wall; and
the extension part extends in the third direction, and the extension part is coupled to the other one of the first side wall and the second side wall.

10. The feed network according to claim 2, wherein the support comprises a slide rail, and the slide rail extends in the second direction; and
the phase shift medium is slidably disposed in the slide rail, and the slide rail is configured to support the phase shift medium and is configured for the phase shift medium to slide in the second direction.

11. The feed network according to claim 10, wherein the support is of a plate-like structure;
the support comprises a first surface and a second surface, and the first surface and the second surface are disposed away from each other;
the first surface is connected to one of the first side wall and the second side wall, and the second surface is disposed opposite to the other one of the first side wall and the second side wall; and
the transmission structure is disposed on the second surface, and the second surface is the bearing surface.

12. The feed network according to claim 11, wherein the slide rail is of a groove-shaped structure provided on the support, and the phase shift medium is slidably disposed in the groove-shaped structure; and
the phase shift medium is nested in the support, and an orthographic projection of the phase shift medium in the second direction is located in an orthographic projection of the support in the second direction.

13. The feed network according to claim 12, wherein in the first direction, a distance between the first surface and the second surface is smaller than a distance between the second surface and the other one of the first side wall and the second side wall.

14. The feed network according to claim 10, wherein in the first direction, one end of the support is connected to the first side wall, and the other end of the support is connected to the second side wall.

15. The feed network according to claim 10, wherein in the third direction, the two ends of the support are respectively connected to the inner walls of the accommodation cavity, and the third direction is perpendicular to both the first direction and the second direction.

16. The feed network according to claim 1, wherein the support is a circuit board or a three-dimensional plastic member.

17. The feed network according to claim 1, wherein each housing comprises a first cable outlet interface and a second cable outlet interface;
a partial structure of the transmission structure is located in the first cable outlet interface, and the first cable outlet interface is configured to connect to a radiating element of an antenna; and
a partial structure of the transmission structure is located in the second cable outlet interface, and the second cable outlet interface is configured to connect to an antenna connector.

18. A phase shifter, comprising a feed network, wherein the feed network comprises a housing, wherein at least one accommodation cavity is disposed in the housing;
a transmission structure, a support, and a phase shift medium are disposed in each accommodation cavity;
the support is located in the accommodation cavity, and the support is connected to at least one inner wall of the accommodation cavity;
in a first direction, the support comprises a bearing surface, an inner wall that is of the accommodation cavity and that is opposite to the bearing surface and the bearing surface are spaced apart, and the transmission structure is disposed on a surface of the bearing surface;
in the first direction, the phase shift medium is disposed between the transmission structure and one of inner walls of the accommodation cavity, and the phase shift medium is slidably connected to the support in a second direction; and
the first direction is a thickness direction of the feed network, the second direction is a sliding direction of the phase shift medium, and the first direction is perpendicular to the second direction.

19. An antenna apparatus, comprising a radiating element and a feed network, wherein the radiating element is electrically connected to a transmission structure of the feed network;
wherein the feed network comprises a housing, wherein at least one accommodation cavity is disposed in the housing;
a transmission structure, a support, and a phase shift medium are disposed in each accommodation cavity;
the support is located in the accommodation cavity, and the support is connected to at least one inner wall of the accommodation cavity;
in a first direction, the support comprises a bearing surface, an inner wall that is of the accommodation cavity and that is opposite to the bearing surface and the bearing surface are spaced apart, and the transmission structure is disposed on a surface of the bearing surface;
in the first direction, the phase shift medium is disposed between the transmission structure and one of inner walls of the accommodation cavity, and the phase shift medium is slidably connected to the support in a second direction; and
the first direction is a thickness direction of the feed network, the second direction is a sliding direction of the phase shift medium, and the first direction is perpendicular to the second direction.
